(19) United States
(12) Patent Application Publication
(10) Pub. No.: US 2007/0048028 A1
(43) Pub. Date: Mar. 1, 2007

(54) Developer and electrophotographic image forming apparatus including the same

(75) Inventors: Yong-sung Kim, Yongin-si (KR); Jeong-hun Pang, Yongin-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/487,351

(22) Filed: Jul. 17, 2006

(30) Foreign Application Priority Data
Aug. 26, 2005 (KR) 10-2005-0078911

(51) Int. Cl. G03G 15/08

(52) U.S. Cl. 399/258

(57) ABSTRACT

An improved developer for an electrophotographic image forming apparatus is provided. The developer includes a developer frame, a plurality of developing cartridges that are sequentially mounted in the developer frame and have a plurality of toner feeding units for receiving respective toners. A plurality of toner cartridges feed the respective toners to the plurality of toner feeding units, respectively. A toner cartridge frame is detachably mounted in the developer frame and in which the plurality of toner cartridges are mounted.

### CROSS-REFERENCE TO RELATED PATENT APPLICATION

This application claims the benefit under 35 U.S.C. § 119(a) of Korean Patent Application No. 10-2005-0078911, filed on Aug. 26, 2005, in the Korean Intellectual Property Office, the entire disclosure of which is hereby incorporated by reference.

### BACKGROUND OF THE INVENTION

1. Field of the Invention

The present invention relates to an electrophotographic image forming apparatus. More particularly, the present invention relates to a developer including a plurality of developing cartridges and a plurality of toner cartridges that are sequentially driven to form a multi-color image and an electrophotographic image forming apparatus including the same.

2. Description of the Related Art

In general, electrophotographic image forming apparatuses form an electrostatic latent image corresponding to a desired image on a photosensitive medium by radiating light onto the photosensitive drum charged to a predetermined potential. The electrostatic latent image is developed using toner to form a toner image. The toner image is transferred onto a sheet of paper and the toner image is fused on the paper, thereby forming the desired image.

A multi-color image forming apparatus generally requires yellow (Y), magenta (M), cyan (C), and black (B) toners. These color toners overlap each other to exhibit a desired multi-color image. Accordingly, the multi-color image forming apparatus requires four developing cartridges for storing respective color toners.

The multi-color image forming apparatus having the four developing cartridges has a larger size and a more complicated structure, compared with a monochromic image forming apparatus for exhibiting a single color.

Each of the developing cartridges has various components, such as a toner storing unit for storing a toner, an agitator for agitating the toner, a developing roller for developing an electrostatic latent image, and a feeding roller for feeding the toner to the developing roller. When the toner is used up, the developing cartridge should be replaced with a new developing cartridge.

The life span of the toner is shorter than those of the other components. Accordingly, if the toner is used up, the developing cartridge should be replaced with a new developing cartridge although the other components thereof can be still used.

Accordingly, a method of feeding only toner to extend the life span of the developing cartridge has been suggested. A toner cartridge for storing toner therein and a developing cartridge are separately provided. When the toner is used up, only the toner cartridge is replaced with a new toner cartridge to feed new toner to the developing cartridge. Thus, the developing cartridge can be used until its life span.

At this time, the developing cartridges and the toner cartridges must be disposed in the image forming apparatus such that they efficiently perform the respective functions by detachably providing the toner cartridges to the developing cartridges, and the toner stored in the toner cartridge must be stably fed to the developing cartridge.

Accordingly, the toner cartridges and the developing cartridges should not interfere with one another, and the total size of the image forming apparatus should be reduced.

Furthermore, the toner should not directly drop from the toner cartridge onto the developing cartridge using free fall in a layout of the image forming apparatus. The toner must be smoothly fed to the developing cartridge although a large distance may exist between where the toner drops and a component of the developing cartridge.

Accordingly, a need exists for an electrophotograhic image forming apparatus having an improved developer having separate developing and toner cartridges.

### SUMMARY OF THE INVENTION

The present invention provides a developer and an electrophotographic image forming apparatus in which the total size of the image forming apparatus may be reduced by separately providing a plurality of developing cartridges and a plurality of toner cartridges.

According to an aspect of the present invention, a developer includes a developer frame, a plurality of developing cartridges that are sequentially mounted in the developer frame and have a plurality of toner feeding units for receiving respective toners, and a plurality of toner cartridges that feed the respective toners to the plurality of toner feeding units, respectively. A toner cartridge frame is detachably mounted in the developer frame and in which the plurality of toner cartridges are mounted.

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other features and advantages of the present invention will become more apparent by describing in detail exemplary embodiments thereof with reference to the attached drawings, in which:

FIG. 1 schematically illustrates an electrophotographic image forming apparatus including a developer according to an exemplary embodiment of the present invention;

FIG. 2 is a perspective view illustrating a relationship between toner feeding units of a plurality of developing cartridges and a plurality of toner cartridges of FIG. 1;

FIG. 3 is a partial perspective view illustrating replacement of the toner cartridge;

FIG. 4 is a perspective view illustrating the developer in which a photosensitive drum is mounted;

FIG. 5 is an exploded perspective view illustrating a structure of the developing cartridge and the toner cartridge of FIG. 1;

FIG. 6 is a perspective view illustrating a driving gear train of the plurality of developing cartridges;

FIG. 7 is a partial perspective view illustrating voltage supply units of the plurality of developing cartridges;

FIG. 8 is a perspective view illustrating the developing cartridge mounted in a developer frame;

FIG. 9 is a partial perspective view illustrating a locking device disposed in a main frame;

FIG. 10 is a perspective view illustrating the developer mounted in the main frame;

FIG. 11 is a partial perspective view illustrating first guide portions mounted in first guide grooves;

FIG. 12 is a partial perspective view illustrating second guide portions mounted in second guide grooves; and

FIG. 13 is a perspective view illustrating transferring power to the toner cartridges.

Throughout the drawings, the same drawing reference numerals will be understood to refer to the same elements, features, and structures.

### DETAILED DESCRIPTION OF EXEMPLARY EMBODIMENTS

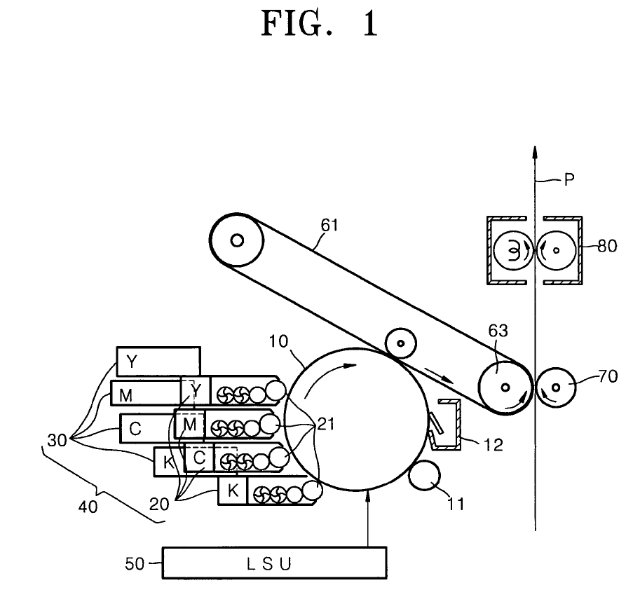

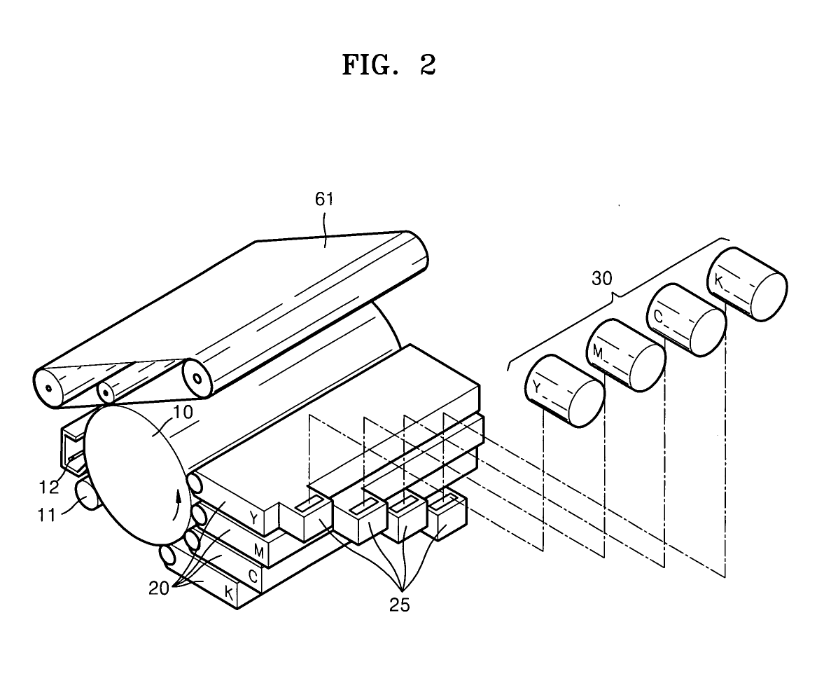

Referring to FIGS. 1 and 2, an electrophotographic image forming apparatus includes a photosensitive drum 10, a developer 40 having a plurality of developing cartridges 20 and a plurality of toner cartridges 30, an intermediate transfer belt 61, a first transfer roller 63, a second transfer roller 70, and a fixing unit 80.

The photosensitive drum 10 has a photoconductive layer formed on the outer circumferential surface of a cylindrical metal drum. Instead of the photosensitive drum 10, a photosensitive belt may be employed. A charging roller 11, which is an example of a charger for charging the photosensitive drum 10 to a uniform potential, is disposed adjacent to the photosensitive drum 10. A cleaning means 12 is provided for removing waste toner remaining on the surface of the photosensitive drum 10 after transferring an image onto the intermediate transfer belt 61.

The charging roller 11 supplies charges to the photosensitive drum 10 while rotating in contact with or in non-contact with the outer circumferential surface of the photosensitive drum 10 to make the outer circumferential surface of the photosensitive drum 10 have a uniform potential. Instead of the charging roller 11, a corona charger may be employed. An exposure unit 50 irradiates light corresponding to image information onto the photosensitive drum 10 charged to the uniform potential to form an electrostatic latent image. The exposure unit 50 generally includes a laser scanning unit (LSU) using a laser diode as a light source.

The plurality of toner cartridges 30Y, 30M, 30C, and 30K contain toners of yellow (Y), magenta (M), cyan (C), and black (K), respectively. The plurality of developing cartridges 20Y, 20M, 20C, and 20K receive the respective color toners from the plurality of toner cartridges 30Y, 30M, 30C, and 30K, and develop the electrostatic latent image formed on the photosensitive drum 10.

Each of the developing cartridges 20 includes a developing roller 21 spaced apart from the photosensitive drum 10 by a development gap. The development gap may be several tens or several hundreds of microns.

The image forming apparatus according to an exemplary embodiment is a multi-pass type image forming apparatus in which the plurality of developing cartridges 20Y, 20M, 20C, and 20K are sequentially driven to form an image. In this multi-pass type image forming apparatus, a development bias may be applied to the developing roller 21K of a selected developing cartridge 20K and may not be applied to the developing rollers 21Y, 21M, and 21C of the other developing cartridges 20Y, 20M, and 20C, or a development preventing bias may be applied to the developing rollers 21Y, 21M, and 21C of the other developing cartridges 20Y, 20M, and 20C. Alternatively, only the developing roller 21K of the selected developing cartridge 20K may rotate and the developing rollers 21Y, 21M, and 21C of the other developing cartridges 20Y, 20M, and 20C do not rotate.

As shown in FIG. 2, the plurality of developing cartridges 20Y, 20M, 20C, and 20K are sequentially disposed in a travel direction of the photosensitive drum 10. Toner feeding units 25 of the plurality of developing cartridges 20Y, 20M, 20C, and 20K are disposed such that they do not overlap each other in the lengthwise direction of the developing cartridges 20. Thus, the plurality of toner cartridges 30Y, 30M, 30C, and 30K do not interfere with each other.

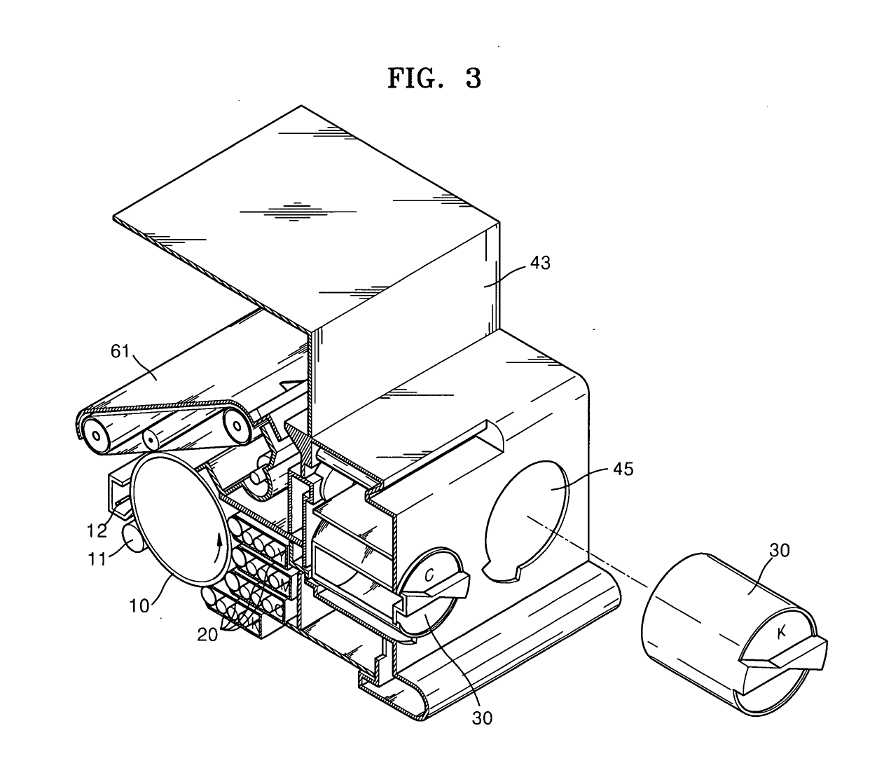

That is, since at least portions of three developing cartridges 20M, 20C, and 20K share heights with the developing cartridges 20Y, 20M, and 20C, respectively, the increase in the height of the image forming apparatus due to the plurality of toner cartridges 30Y, 30M, 30C, and 30K may be minimized. Furthermore, the plurality of toner cartridges 30Y, 30M, 30C, and 30K may be disposed such that they do not interfere with each other or with the developing cartridges 20Y, 20M, 20C, and 20K. Thus, as shown in FIG. 3, if portions of the toner cartridges 30 are exposed outside of the image forming apparatus, the toner cartridges 30 may be mounted or dismounted without opening the image forming apparatus, thereby improving replacement convenience.

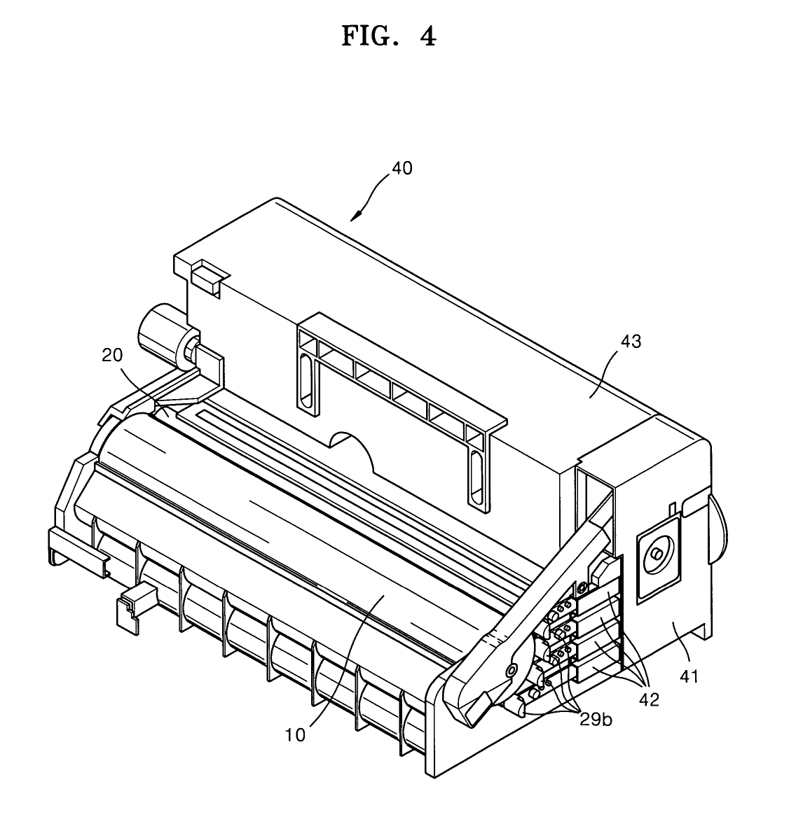

Referring to FIGS. 3 and 4, the developer 40 includes a developer frame 41, a toner cartridge frame 43 detachably mounted in the developer frame 41 and having mounting holes 45 in which the plurality of toner cartridges 30 may be detachably mounted, the plurality of developing cartridges 20 detachably mounted in the developer frame 41, and the plurality of toner cartridges 30 for storing the respective color toners therein.

The photosensitive drum 10 may be detachably mounted in the developer frame 41 and the life span of the developer 40 depends on the life span of the photosensitive drum 10.

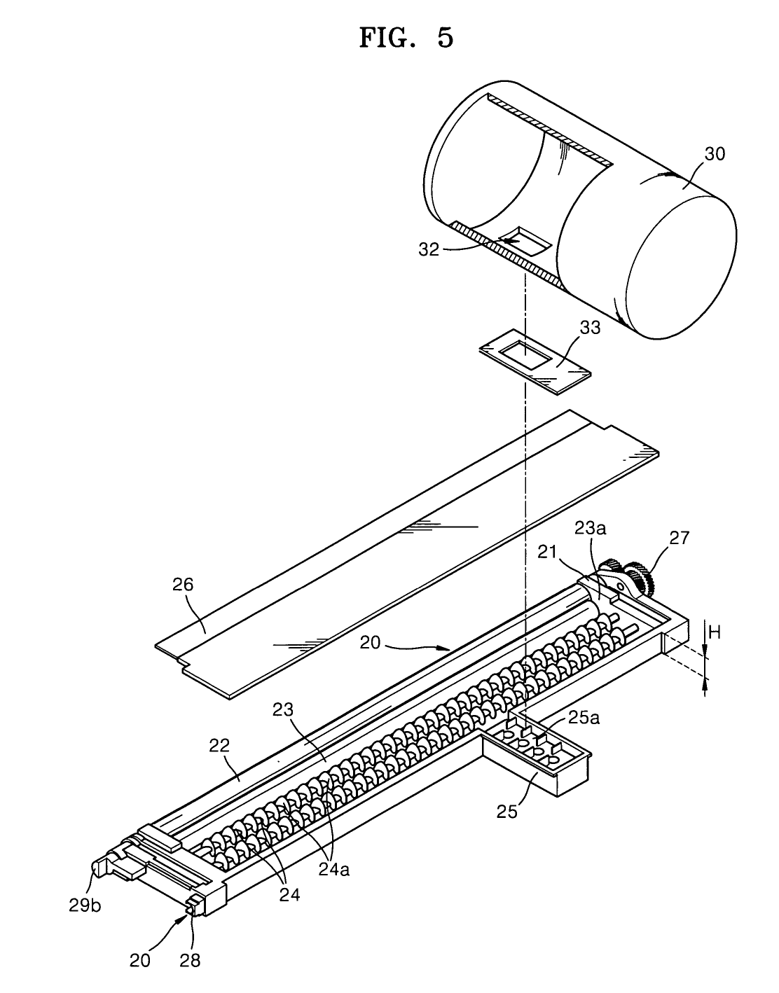

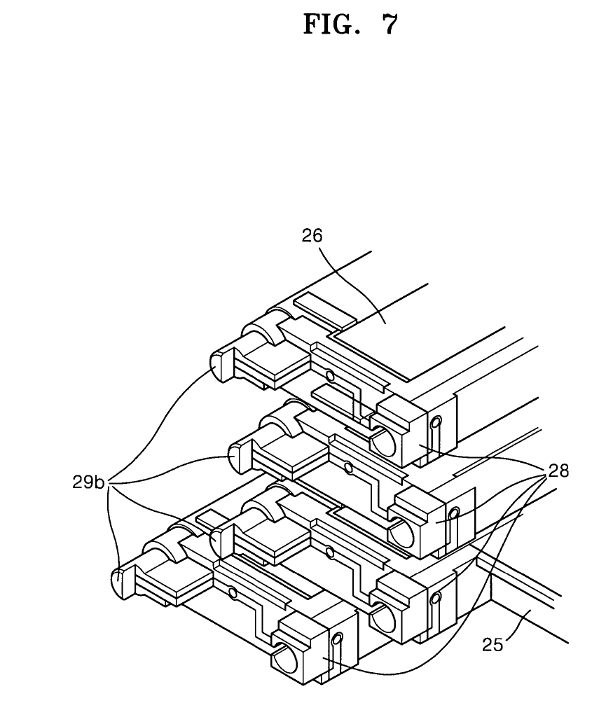

Referring to FIGS. 5 through 7, each of the developing cartridges 20 includes a receiving unit 21 in which the developing roller 22, a feeding roller 23, and a plurality of augers 24 are provided; a toner feeding unit 25 for connecting the receiving unit 21 with each of the toner cartridges 30; and a conveying belt 25a for conveying the toner into the receiving unit 21.

The developing roller 22 develops the electrostatic latent image formed on the photosensitive drum 10 using the toner to form an image. A control blade 26 for controlling the thickness of the toner adhered to the outer circumferential surface of the developing roller 22 is disposed above the developing roller 22. The control blade 26 covers the receiving unit 21 to protect the receiving unit 21. The developing roller 22 is exposed outside of the receiving unit 21 and faces the photosensitive drum 10.

The feeding roller 23 adheres the toner (non-magnetic toner) to the developing roller 22, such as by triboelectrification, while rotating in contact with the developing roller 22.

The plurality of augers 24 receive the toner from the toner feeding unit 25 and feed the toner to the developing roller 22. A plurality of rotary wings 24a are provided in the plurality of augers 24. The conveying directions of the plurality of the augers 24 may be opposite to each other.

The toner feeding unit 25 extends rearwardly from the receiving unit 21 by a predetermined length. A feeding hole 33 for receiving the toner from each of the toner cartridges 30 is provided in the upper surface of the toner feeding unit 25. An outlet 32 corresponding to the feeding hole 33 is provided in each of the toner cartridges 30. Each of the toner cartridges 30 includes a shutter (not shown) for opening or shutting the outlet 32. When each toner cartridge 30 is mounted in each developing cartridge 20, the shutter (not shown) opens the outlet 32 such that the toner is fed to the toner feeding unit 25. When each toner cartridge 30 is removed from each developing cartridge 20, the shutter shuts the outlet 32 such that the toner is substantially prevented from being fed to the toner feeding unit 25.

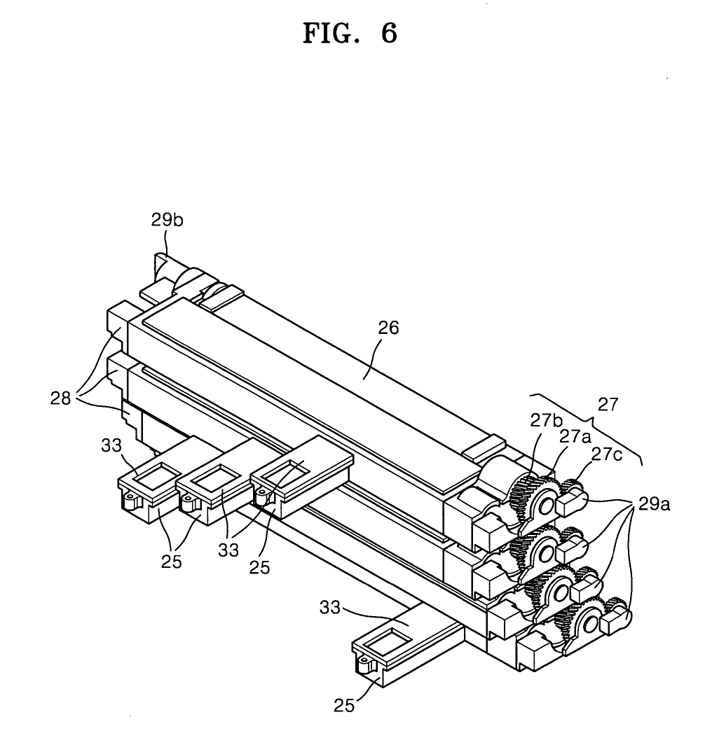

A driving gear train 27 for driving the developing roller 22, the feeding roller 23, and the plurality of augers 24 is provided at one side of each of the developing cartridges 20. The driving gear train 27 may have a height less than the height (H) of each developing cartridge 20. To this end, the plurality of developing cartridges 20 may be disposed such that they overlap each other in a vertical direction, as shown in FIG. 6, and thus power may be efficiently transferred to the developing cartridges 20 while occupying a minimum space.

The driving gear train 27 includes a main gear 27a provided on the shaft 23a of the feeding roller 23. A developing roller gear 27c is connected to the main gear 27a for receiving the power from the main gear 27a. A feeding roller gear 27b is disposed on the shaft 23a of the feeding roller 23 for transferring the power to the plurality of augers 24 when the shaft 23a of the feeding roller 23 rotates. Accordingly, the main gear 27a rotates by external power to drive the developing roller 22, the feeding roller 23, and the plurality of augers 24.

A power supply unit 28 for supplying a voltage to the components is disposed at the other side of each of the developing cartridges 20. The power supply unit 28 is provided at the back side of each of the developing cartridges 20 toward the toner feeding unit 25.

Furthermore, a first guide portion 29a is provided at one side of each of the developing cartridges 20, that is, the side having the driving gear train 27; and a second guide portion 29b is disposed at the other side of each of the developing cartridges 20, that is, the side having the power supply unit 28. The first guide portion 29a and the second guide portion 29b may be provided at the front side of each of the developing cartridges 20.

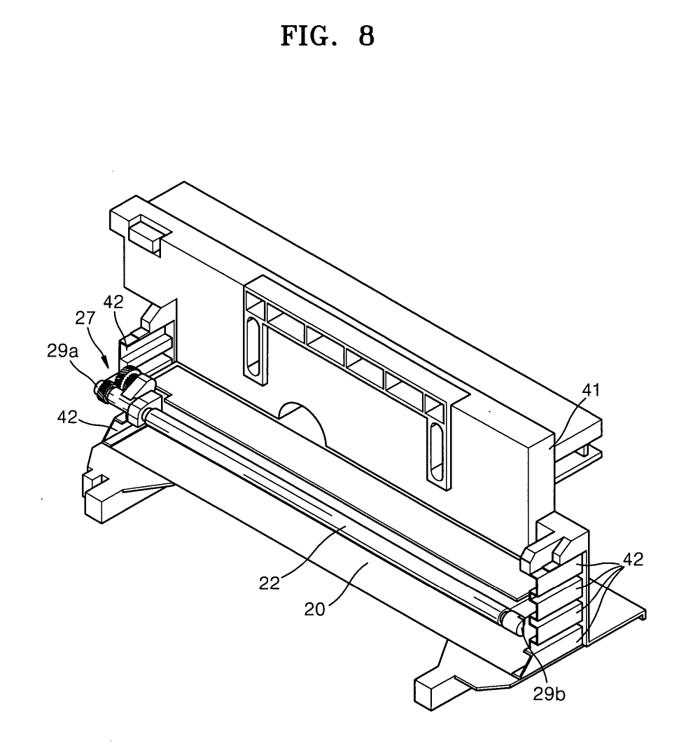

Referring to FIG. 8, a plurality of mounting guide grooves 42 are formed in the developer frame 41 such that the plurality of developing cartridges 20 are mounted therein, respectively. When the developing cartridges 20 are mounted in the mounting guide grooves 42, the developing cartridges 20 slide along the mounting guide grooves 42 and are mounted in the developer frame 41. At this time, the first guide portion 29a and the second guide portion 29b are exposed outside of the developer frame 41 and not mounted in the mounting guide groove 42.

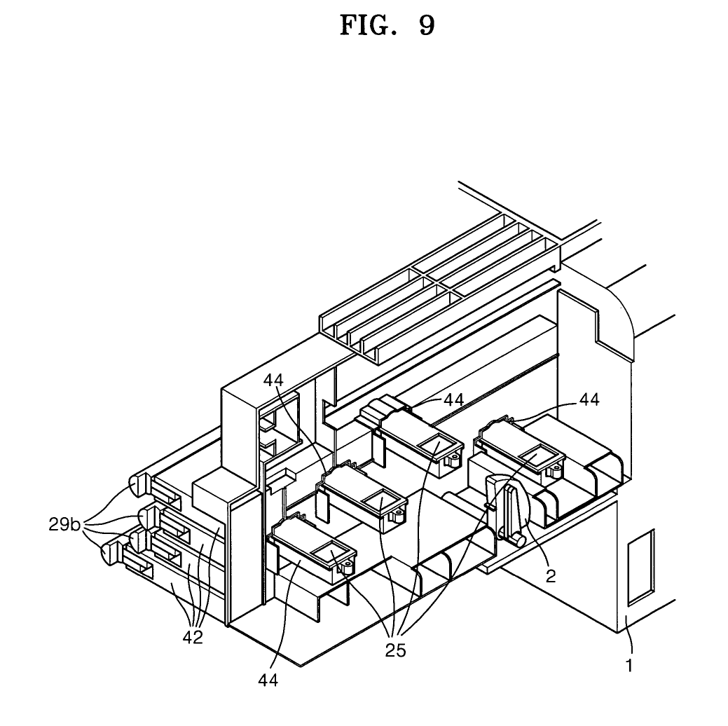

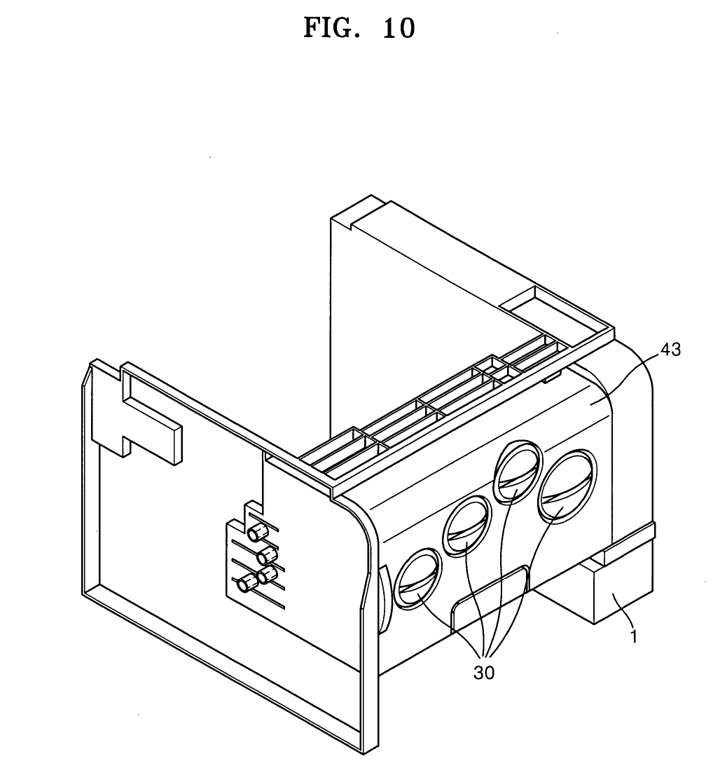

Referring to FIG. 9, a plurality of perforated holes 44 through which the plurality of toner feeding units 25 penetrate when the plurality of developing cartridges 20 are mounted in the developing frame 41 is provided in the developer frame 41 corresponding to the plurality of toner feeding units 25. As shown in FIG. 10, the toner cartridge frame 43 is mounted in the developer frame 41 and the plurality of toner cartridges 30 are mounted in the mounting holes 45.

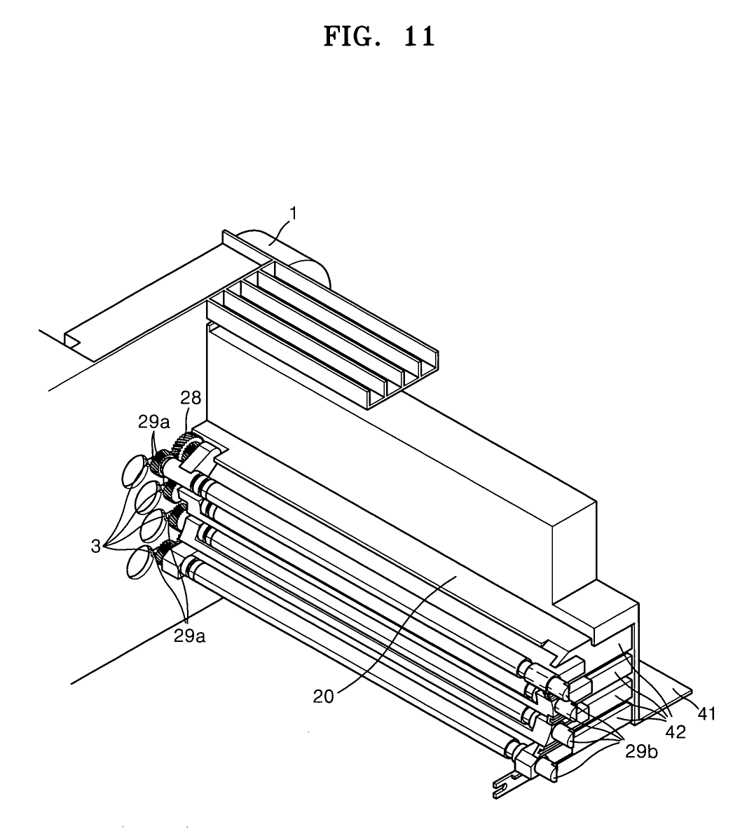

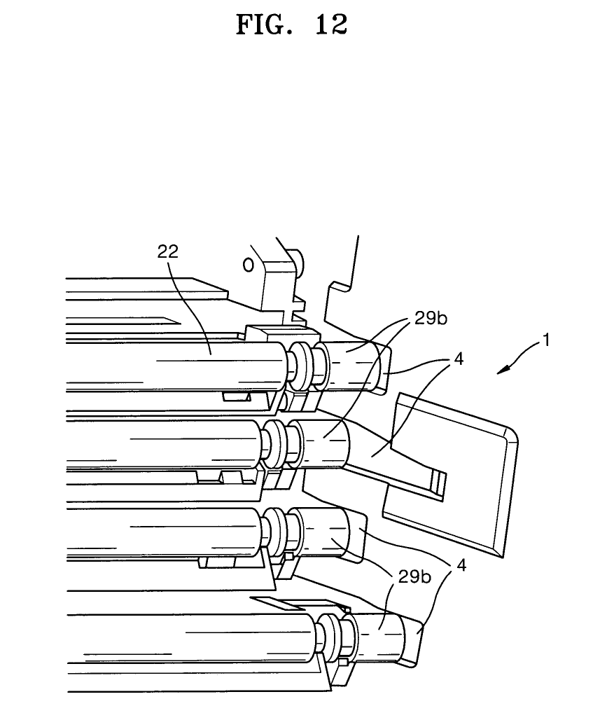

Referring to FIGS. 10 through 12, the plurality of developing cartridges 20 are mounted in the developer frame 41, the toner cartridge frame 43 is mounted in the developer frame 41, the plurality of toner cartridges 30 are mounted in the mounting holes 45, and the developer 40 is mounted in the main frame 1.

At this time, the plurality of first guide portions 29a and the plurality of second guide portions 29b disposed in the plurality of developing cartridges 20 are mounted and fixed in a plurality of first guide grooves 3 and a plurality of second guide grooves 4 formed in the main frame 1. That is, the plurality of first guide portions 29a slide along the plurality of first guide grooves 3 and the plurality of second guide portions 29b slide along the plurality of second guide grooves 4. Accordingly, the developer 40 is mounted in the main frame 1.

Accordingly, when the developer 40 is mounted in the main frame 1, the developer 40 is always positioned at any one location of the main frame 1 by the first guide grooves 3 and the second guide grooves 4 such that it can be aligned with the other components such as the transfer belt 61 and so on (see FIG. 1).

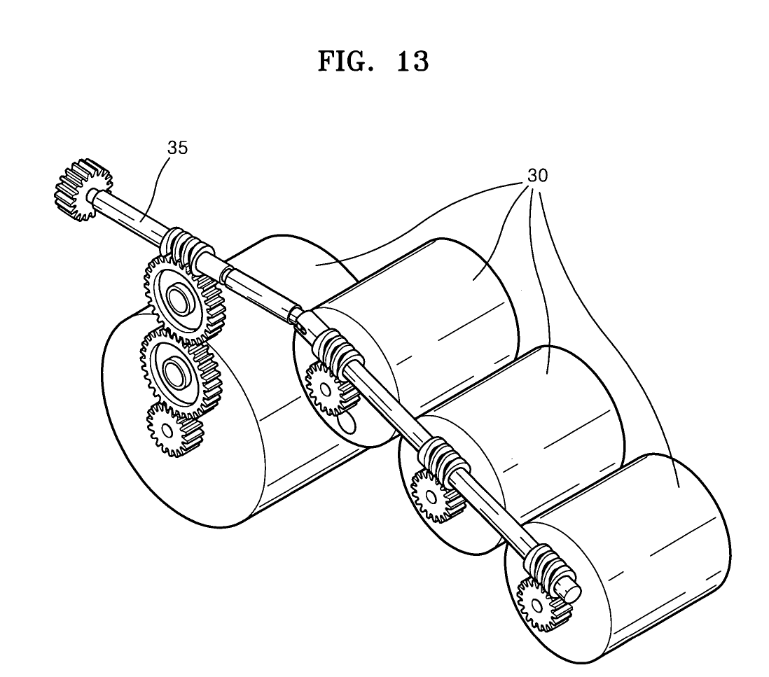

Referring to FIG. 13, a power delivering shaft 35 efficiently delivers power to the plurality of toner cartridges 30 mounted in the toner cartridge frame 43 (see FIG. 10) using a universal joint to drive the agitator (not shown) provided therein.

Referring back to FIG. 9, a locking device 2 is disposed in the main frame 1 to fix the developer 40 to the main frame 1 after the developer 40 is mounted in the main frame 1. After the developer 40 is mounted in the main frame 1, the developer 40 is fixed to the main frame 1 by rotating the locking device 2 in a clockwise or counterclockwise direction.

Accordingly, the developer 40 is mounted at a predetermined location of the main frame 1 using the first guide grooves 3, the second guide grooves 4 and the locking device 2 provided in the main frame 1.

As described above, in a developer and an electrophotographic image forming apparatus according to exemplary embodiments of the present invention, the developing cartridges and the toner cartridges are separately provided and thus the size of the electrophotographic image forming apparatus may be reduced. Furthermore, because the developer may be mounted at a predetermined location of a main frame, the interaction with the other components may be smoothly realized.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A developer, comprising:
a developer frame;
a plurality of developing cartridges sequentially mounted in the developer frame having a plurality of toner feeding units for receiving respective toners;
a plurality of toner cartridges feeding the respective toners to the plurality of toner feeding units, respectively; and
a toner cartridge frame detachably mounted in the developer frame and in which the plurality of toner cartridges are mounted.

2. The developer according to claim 1, whereineach of the developing cartridges includes
a receiving unit in which a developing roller, a feeding roller, and a plurality of augers are provided; and
a driving gear train for driving the developing roller, the feeding roller, and the plurality of augers, the driving gear train being disposed at one side of the receiving unit and having a height less than a height of each of the developing cartridges.

3. The developer according to claim 2, wherein the driving gear train has a main gear connected to the shaft of the feeding roller to deliver external power to the developing roller and the plurality of augers.

4. The developer according to claim 1, wherein a power supply unit is disposed at the other side of each of the plurality of developing cartridges toward the plurality of toner feeding units and receives an external voltage.

5. The developer according to claim 1, wherein a plurality of mounting guide grooves in the developer frame are adapted to receive the plurality of developing cartridges therein, respectively.

6. The developer according to claim 5, wherein the developing roller is exposed outside of the developer frame when the plurality of developing cartridges are mounted in the plurality of mounting guide grooves, respectively.

7. An electrophotographic image forming apparatus, comprising:
a main frame;
a developer detachably mounted in the main frame; and
a photosensitive drum on which an electrostatic latent image corresponding to an image is formed,
wherein the developer includes
a developer frame;
a plurality of developing cartridges sequentially mounted in the developer frame having a plurality of toner feeding units for receiving respective toners;
a plurality of toner cartridges feeding the respective toners to the plurality of toner feeding units, respectively; and
a toner cartridge frame detachably mounted in the developer frame and in which the plurality of toner cartridges are mounted.

8. The electrophotographic image forming apparatus according to claim 7, wherein each of the developing cartridges includes
a receiving unit in which a developing roller, a feeding roller, and a plurality of augers are provided; and
a driving gear train for driving the developing roller, the feeding roller, and the plurality of augers, the driving gear train being disposed at one side of the receiving unit and having a height less than a height of each of the developing cartridges.

9. The electrophotographic image forming apparatus according to claim 8, wherein the driving gear train has a main gear connected to the shaft of the feeding roller to deliver external power to the developing roller and the plurality of augers.

10. The electrophotographic image forming apparatus according to claim 7, wherein a power supply unit disposed at the other side of each of the plurality of developing cartridges toward the plurality of toner feeding units and receives an external voltage.

11. The electrophotographic image forming apparatus according to claim 7, wherein a plurality of mounting guide grooves in the developer frame are adapted to receive the plurality of developing cartridges therein, respectively.

12. The electrophotographic image forming apparatus according to claim 11, wherein the developing roller is exposed outside of the developer frame when the plurality of developing cartridges are mounted in the plurality of mounting guide grooves, respectively.

13. The electrophotographic image forming apparatus according to claim 12, wherein
a first guide portion protrudes from one side of each of the plurality of developing cartridges;
a second guide portion protrudes from the other side of each of the plurality of developing cartridges;
a first guide groove and a second guide groove in the main frame are adapted to receive the first guide portion and the second guide portion, respectively.

14. The electrophotographic image forming apparatus according to claim 13, wherein the first guide portion and the second guide portion are disposed at each side of the receiving unit such that the first guide portion and the second guide portion are exposed from the developer frame when each of the plurality of developing cartridges are mounted in the developer frame.

15. The electrophotographic image forming apparatus according to claim 7, wherein a locking device for fixing the developer to the main frame is disposed in the main frame.

16. The electrophotographic image forming apparatus according to claim 7, wherein the photosensitive drum is detachably mounted in the developer frame.

17. A developer for an electrophotographic image forming apparatus, comprising:
a developer frame;
a plurality of developing cartridges mounted in the developer frame;
a toner feeding unit connected to each of the developing cartridges;
a toner cartridge frame detachably mounted in the developer frame; and
a plurality of toner cartridges mounted in the toner cartridge frame, each toner cartridge being disposed to supply toner to one of the plurality of developing cartridges.

18. A developer for an electrophotographic image forming apparatus according to claim 17, wherein the plurality of developing cartridges are sequentially mounted in the developer frame.

19. A developer for an electrophotographic image forming apparatus according to claim 17, wherein each of the developing cartridges includes
a receiving unit in which a developing roller, a feeding roller, and a plurality of augers are disposed; and
a driving gear train for driving the developing roller, the feeding roller, and the plurality of augers, the driving gear train being disposed at a first end of the receiving unit and having a height less than a height of each of the developing cartridges.

20. A developer for an electrophotographic image forming apparatus according to claim 19, wherein the driving gear train has a main gear connected to the shaft of the feeding roller to deliver external power to the developing roller and the plurality of augers.

21. A developer for an electrophotographic image forming apparatus according to claim 19, wherein a power supply unit is disposed at a second end of each of the plurality of developing cartridges toward the plurality of toner feeding units and receives an external voltage.

22. A developer for an electrophotographic image forming apparatus according to claim 17, wherein a plurality of mounting guide grooves in the developer frame are adapted to receive the plurality of developing cartridges therein.

23. A developer for an electrophotographic image forming apparatus according to claim 22, wherein the developing roller is exposed outside of the developer frame when the plurality of developing cartridges are mounted in the plurality of mounting guide grooves.

24. A developer for an electrophotographic image forming apparatus according to claim 17, wherein an opening in each of the toner cartridges is disposed above one of the toner feeding units to supply toner thereto.

25. A developer for an electrophotographic image forming apparatus according to claim 17, wherein each of the toner feeding units is unitarily formed with one of the developing cartridges.

26. A developer for an electrophotographic image forming apparatus according to claim 19, wherein each of the toner feeding units has a conveyor belt to supply toner to the receiving unit of the developing cartridge to which the toner feeding unit is connected.
